(19) United States
(12) Patent Application Publication
(10) Pub. No.: US 2020/0320477 A1
(43) Pub. Date: Oct. 8, 2020

(54) VEHICLE SELECTION APPARATUS, VEHICLE SELECTION METHOD, AND VEHICLE SELECTION PROGRAM

(71) Applicant: TOYOTA JIDOSHA KABUSHIKI KAISHA, Toyota-shi (JP)

(72) Inventors: Naoko YOSHIZAWA, Nagoya-shi (JP); Takumi FUKUNAGA, Nagoya-shi (JP); Shinichirou FUJII, Kawasaki-shi (JP); Hiromitsu FUJII, Kariya-shi (JP)

(73) Assignee: TOYOTA JIDOSHA KABUSHIKI KAISHA, Toyota-shi (JP)

(21) Appl. No.: 16/811,144

(22) Filed: Mar. 6, 2020

(30) Foreign Application Priority Data
Apr. 8, 2019 (JP) 2019-073773

(51) Int. Cl. G06Q 10/08; G07C 9/00

(52) U.S. Cl. CPC G06Q 10/08355; G07C 9/00896; G06Q 10/0832

(57) ABSTRACT

The vehicle selection apparatus includes a memory and a processor including hardware. The processor selects a vehicle for collection and delivery of a package that is a collection and delivery target, based on parking and stopping information that includes information about the positions of a plurality of vehicles parked or stopped in a predetermined region, of which the vehicle cabins are usable for package reception, and information about the parking and stopping of the vehicles.

### INCORPORATION BY REFERENCE

The disclosure of Japanese Patent Application No. 2019-073773 filed on Apr. 8, 2019 including the specification, drawings and abstract is incorporated herein by reference in its entirety.

### BACKGROUND

### 1. Technical Field

The disclosure relates to a vehicle selection apparatus, a vehicle selection method, and a vehicle selection program.

### 2. Description of Related Art

A technique in which a trunk of a general passenger car, that is registered as a vehicle for package reception in advance, is used as a delivery handing over place when a courier collects and delivers packages has been known (for example, refer to Japanese Unexamined Patent Application Publication No. 2006-206225 (JP 2006-206225 A)). In the above-described technique, an authentication process is performed between a collection and delivery communication device of a collection and delivery company and a vehicle communication device installed in a designated vehicle when collection and delivery of a package are performed and a trunk of the designated vehicle becomes able to be locked or unlocked in a case where the authentication is successful.

### SUMMARY

Meanwhile, in a region in which a plurality of vehicles can be parked or stopped at the same time as in the case of a monthly parking lot, there may be a plurality of vehicles registered for package reception. In such a case, it cannot be said that all of the vehicles for package reception are effectively utilized since each of the vehicles for package reception is merely registered individually in the case of the technique in JP 2006-206225 A.

The disclosure provides a vehicle selection apparatus, a vehicle selection method, and a vehicle selection program with which it is possible to effectively utilize a plurality of vehicles registered for package reception in a predetermined region.

A first aspect of the disclosure relates to a vehicle selection apparatus including a memory and a processor including hardware. The processor selects a vehicle for collection and delivery of a package that is a collection and delivery target, based on parking and stopping information that includes information about the positions of a plurality of vehicles parked or stopped in a predetermined region, of which the vehicle cabins are usable for package reception, and information about the parking and stopping of the vehicles.

The processor may select the vehicle for collection and delivery of the package while referring to schedule information that is registered by each of the owners of the vehicles.

In this case, it is possible to select an appropriate vehicle in accordance with the schedule of the owners of the vehicles and thus it is possible to prevent a collection and delivery failure that is caused by absence of a vehicle.

The processor may select the vehicle for collection and delivery of the package while referring to information about a condition for collection and delivery that is registered in advance by the owners of the vehicles.

In this case, it is possible to realize package collection and delivery while respecting the intentions of the owners of the vehicles.

The processor may select the vehicle for collection and delivery of the package in accordance with the kind of the package.

In this case, it is possible to select an appropriate vehicle in accordance with the kind of the package.

The processor may select the vehicle for collection and delivery of the package while referring to evaluation information obtained through evaluation performed by at least any of a past collection and delivery service user, the owners of the vehicles, and a collection and delivery agent of the package.

In this case, it is possible to select an appropriate vehicle based on evaluation performed by any of persons concerned with collection and delivery of the package.

The processor may transmit collection and delivery information of the package that includes information about the selected vehicle to a collection and delivery agent terminal that is associated with a collection and delivery agent of the package and that transmits a signal requesting the selected vehicle to lock or unlock a vehicle cabin.

In this case, the collection and delivery agent who carries the collection and delivery agent terminal receiving the collection and delivery information can accurately grasp the collection and delivery destination of the package that is the collection and delivery target.

The processor may receive a request for issuance of authentication information, which is needed to lock or unlock the vehicle cabin of the selected vehicle, from the collection and delivery agent terminal, transmit the request for issuance to an authentication management apparatus that manages the authentication information, and transmit the authentication information received from the authentication management apparatus to the collection and delivery agent terminal.

In this case, it is possible to reliably give a right to lock and unlock the vehicle cabin to the collection and delivery agent terminal by transmitting, to the collection and delivery agent terminal, the authentication information that is received from the authentication management apparatus in response to the request for issuance of the authentication information that is received from the collection and delivery agent terminal.

The processor may receive a request for issuance of authentication information, which is needed to lock or unlock the vehicle cabin of the selected vehicle, from the collection and delivery agent terminal, issue the authentication information in response to the request for issuance, and transmit the issued authentication information to the collection and delivery agent terminal.

In this case, since the authentication information is issued by the processor, it is possible to efficiently transmit the authentication information to the collection and delivery agent terminal.

The processor may acquire collection and delivery information of the package and parking and stopping information of the vehicles from a vehicle management apparatus that manages the parking and stopping information of the vehicles, transmit a request for issuance of authentication information, which is needed to lock or unlock a vehicle cabin of the selected vehicle, to the vehicle management apparatus after selection of the vehicle for collection and delivery of the package, and transmit a vehicle cabin unlocking request to a vehicle-mounted device of the selected vehicle by using the authentication information received from the vehicle management apparatus.

In this case, since the authentication information is acquired and the vehicle cabin unlocking request is transmitted to the vehicle-mounted device after the vehicle for collection and delivery of the package is selected based on the collection and delivery information and the parking and stopping information received from the vehicle management apparatus, it is possible to efficiently select the vehicle for collection and delivery and unlock the vehicle.

A second aspect of the disclosure relates to a vehicle selection method performed by a vehicle selection apparatus that includes a memory and a processor including hardware. The vehicle selection method includes reading, from the memory, parking and stopping information that includes information about the positions of a plurality of vehicles parked or stopped in a predetermined region, of which vehicle cabins are usable for package reception, and information about the parking and stopping of the vehicles to select a vehicle for collection and delivery of a package that is a collection and delivery target.

A third aspect of the disclosure relates to a vehicle selection program executed by a vehicle selection apparatus that includes a memory and a processor including hardware. The vehicle selection program causes the vehicle selection apparatus to select a vehicle for collection and delivery of a package that is a collection and delivery target based on parking and stopping information that includes information about the positions of a plurality of vehicles parked or stopped in a predetermined region, of which vehicle cabins are usable for package reception, and information about the parking and stopping of the vehicles.

According to the aspects of the disclosure, since the vehicle for collection and delivery of the package that is the collection and delivery target is selected based on the parking and stopping information that includes the information about the positions of the vehicles parked or stopped in the predetermined region, of which the vehicle cabins are usable for package reception, and the information about the parking and stopping of the vehicles, it is possible to select a vehicle conforming to a parking and stopping situation and thus it is possible to effectively utilize a vehicle registered for package reception in a predetermined region.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a diagram illustrating the outline of a collection and delivery system provided with a vehicle selection apparatus according to Embodiment 1;

FIG. 2 is a block diagram illustrating the functional configuration of the collection and delivery system provided with the vehicle selection apparatus according to Embodiment 1;

FIG. 3 is a diagram schematically illustrating parking and stopping information stored in the vehicle selection apparatus according to Embodiment 1;

FIG. 4 is a sequence diagram illustrating the outline of processing performed when a vehicle cabin of a vehicle is unlocked in a collection and delivery system provided with the vehicle selection apparatus according to Embodiment 1;

FIG. 5 is a sequence diagram illustrating the outline of processing performed when a vehicle cabin of a vehicle is locked in the collection and delivery system provided with the vehicle selection apparatus according to Embodiment 1;

FIG. 6 is a block diagram illustrating the functional configuration of a collection and delivery system provided with a vehicle selection apparatus according to Embodiment 2;

FIG. 7 is a sequence diagram illustrating the outline of processing performed when a vehicle cabin of a vehicle is locked in a collection and delivery system provided with a vehicle selection apparatus according to Embodiment 2;

FIG. 8 is a block diagram illustrating the functional configuration of a collection and delivery system provided with a vehicle selection apparatus according to Embodiment 3;

FIG. 9 is a sequence diagram illustrating the outline of processing performed when a vehicle cabin of a vehicle is locked in a collection and delivery system provided with a vehicle selection apparatus according to Embodiment 3; and

FIG. 10 is a block diagram illustrating the functional configuration of a collection and delivery system provided with a vehicle selection apparatus according to Embodiment 4.

### DETAILED DESCRIPTION OF EMBODIMENTS

Hereinafter, an embodiment will be described with reference to the attached drawings.

### Embodiment 1

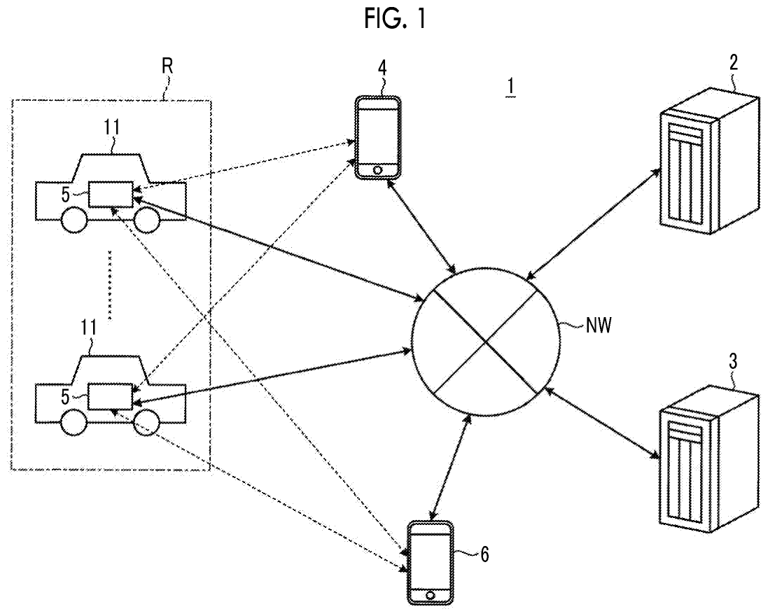

FIG. 1 is a diagram illustrating the outline of a collection and delivery system provided with a vehicle selection apparatus according to Embodiment 1. A collection and delivery system 1 in FIG. 1 is a system in which packages are collected and delivered by means of vehicle cabins of a plurality of vehicles 11, the vehicles 11 being parked or stopped in a predetermined region R and registered as vehicles for package reception in advance. The vehicle cabins of the vehicles 11 include trunks and boarding spaces of the vehicles 11. The region R is, for example, a closed region such as a parking lot in which the vehicles 11 registered in advance are parked. However, the disclosure is not limited thereto.

The collection and delivery system 1 is provided with a management server 2 that manages collection and delivery of packages, a center server 3 that manages the opening and closing of the vehicle cabins of the vehicles 11, a collection and delivery agent terminal 4 associated with a collection and delivery agent, a plurality of vehicle-mounted devices 5 installed in the vehicles 11 respectively, and a request source terminal 6 associated with the source of request for collection and delivery of packages. The management server 2, the center server 3, the collection and delivery agent terminal 4, the vehicle-mounted devices 5, and the request source terminal 6 are communicatably connected to a communication network NW. In addition, the collection and delivery agent terminal 4 and the vehicle-mounted devices 5 are communicatably connected to each other by means of short-range wireless communication. The communication network NW is one of a local area network (LAN), a wide area network (WAN), a public line, a virtual private network (VPN), and an exclusive line or a combination of two or more of those described above. The communication network NW is a combination of a wired communication network and a wireless communication network. In addition, examples of short-range wireless communication standards include Bluetooth (registered trade mark) Low Energy (BLE), Near Field Communication (NFC), Ultra wide-band (UWB), and WiFi (registered trade mark).

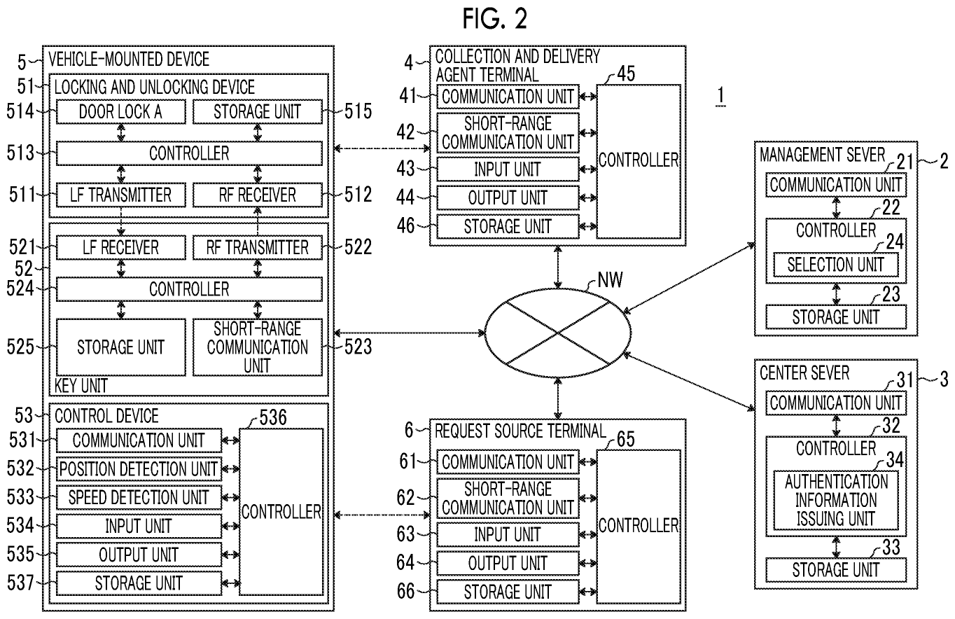

FIG. 2 is a block diagram illustrating the functional configuration of the collection and delivery system 1. Note that, in FIG. 2, one vehicle-mounted device 5 is shown as the representative of the vehicle-mounted devices 5 in the region R. Hereinafter, a functional configuration will be described for each constituent element of the collection and delivery system 1.

### Management Server 2

The management server 2 is a vehicle selection apparatus according to Embodiment 1 and is a vehicle management apparatus that manages parking and stopping information of the vehicles 11. The management server 2 includes a communication unit 21, a controller 22, and a storage unit 23.

The communication unit 21 is an interface that communicates with the center server 3, the collection and delivery agent terminal 4, and the request source terminal 6 via the communication network NW.

The controller 22 includes a selection unit 24. The selection unit 24 selects a vehicle for collection and delivery of a package that is a collection and delivery target based on the parking and stopping information, the parking and stopping information including the parking and stopping positions and the parking and stopping periods of the vehicles 11 that can be parked or stopped in the region R and of which vehicle cabins can be provided for package reception. The parking and stopping information is information stored in the storage unit 23 and is information that the selection unit 24 can refer to appropriately.

The controller 22 is a processor that is configured by using one or a combination of pieces of hardware including a general-purpose processor such as a central processing unit (CPU) and a dedicated integrated circuit such as a field programmable gate array (FPGA) that performs a specific function. The controller 22 performs various calculation processes for operating the management server 2 by reading various programs stored in the storage unit 23.

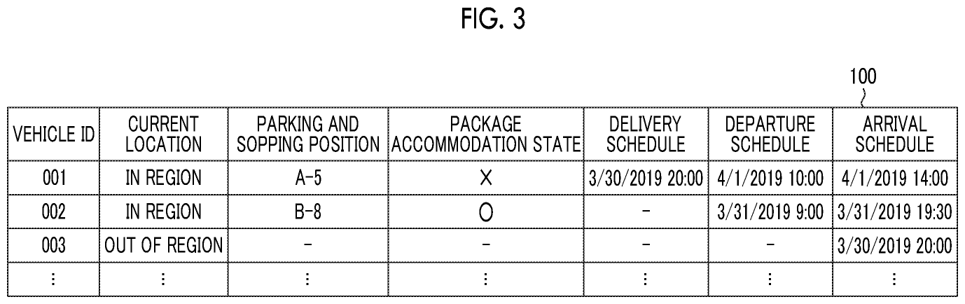

The storage unit 23 stores the parking and stopping information that includes information about the positions of the vehicles 11 that can be parked or stopped in the region R and of which the vehicle cabins are usable as package reception spaces and the parking and stopping of the vehicles 11. FIG. 3 is a diagram schematically illustrating the parking and stopping information stored in the storage unit 23. In a table 100 shown in FIG. 3, a vehicle ID, a current position, a parking and stopping position in the region R, a package accommodation state, a package delivery schedule, and departure and arrival schedules of the vehicle 11 are written for each vehicle. The current positions and the parking and stopping positions are registered based on position information transmitted from the vehicle-mounted devices 5. In addition, the delivery schedules are registered based on information transmitted from the request source terminal 6. In addition, the departure and arrival schedules are registered based on schedule information transmitted from the vehicle-mounted devices 5. For example, the vehicle 11 of which the vehicle ID is 001 (hereinafter, will be referred to as vehicle 001) has been parked or stopped at a position A-5 in the region R and there is no package currently accommodated in a vehicle cabin thereof. A package is scheduled to be delivered to the vehicle 001 at 20:00 on Mar. 30, 2019. In addition, the vehicle 001 is scheduled to depart from the region R at 10:00 on Apr. 1, 2019 and to arrive at the region R at 14:00 on the same day. Note that, the parking and stopping information may be stored in a server different from the management server 2 instead of being stored in the storage unit 23.

The storage unit 23 further stores collection and delivery information about collection and delivery of a package and various programs for operating the management server 2. The collection and delivery information includes information about a requester, the kind of the package, the time of collection and delivery, information about a collection and delivery agent, and information about the vehicle 11 as a collection and delivery destination. The various programs include a vehicle selection program for the selection unit 24 selecting the vehicle 11 for collection and delivery of a package that is a collection and delivery target from the vehicles 11.

The storage unit 23 is configured by using a volatile memory such as a random access memory (RAM) and a non-volatile memory such as a read only memory (ROM). Note that, the storage unit 23 may be configured by using a computer-readable recording medium such as a memory card that can be mounted from the outside. The various programs stored in the storage unit 23 can also be widely distributed by being recorded in a computer-readable recording medium such as a hard disk, a flash memory, a CD-ROM, a DVD-ROM, and a flexible disk.

### Center Server 3

The center server 3 is an authentication management apparatus that manages authentication information of the vehicles 11. The center server 3 includes a communication unit 31, a controller 32, and a storage unit 33.

The communication unit 31 is an interface that communicates with the management server 2 via the communication network NW.

The controller 32 includes an authentication information issuing unit 34. The authentication information issuing unit 34 issues authentication information for the locking or unlocking of the vehicles 11. When the authentication information issuing unit 34 receives a request for issuance of authentication information for the locking and unlocking of the vehicle 11 from the collection and delivery agent terminal 4 via the management server 2, the authentication information issuing unit 34 transmits authentication information corresponding to a key unit 52 to the collection and delivery agent terminal 4 via the management server 2. The authentication information issuing unit 34 may generate authentication information including information about an expiration date.

The controller 32 is a processor configured by using one or a combination of pieces of hardware such as a CPU or an FPGA. The controller 32 performs various calculation processes for operating the center server 3 by reading various programs stored in the storage unit 33.

The storage unit 33 stores information needed for the authentication information issuing unit 34 to issue authentication information and various programs for operating the center server 3. The storage unit 33 is configured by using a RAM, a ROM, and the like.

### Collection and Delivery Agent Terminal 4

The collection and delivery agent terminal 4 includes a communication unit 41, a short-range communication unit 42, an input unit 43, an output unit 44, a controller 45, and a storage unit 46. The collection and delivery agent terminal 4 is a terminal associated with a package collection and delivery agent and is a terminal carried by the collection and delivery agent. The collection and delivery agent terminal 4 is configured by using a smartphone, a cellular phone, a tablet terminal, a personal information terminal, a wearable computer, or the like.

The communication unit 41 is an interface that communicates with at least the management server 2 via the communication network NW.

The short-range communication unit 42 is an interface that communicates with the vehicle-mounted devices 5 by means of short-range wireless communication. The short-range communication unit 42 performs short-range wireless communication based on any of standards including BLE, NFC, UWB, and WiFi (registered trademark).

The input unit 43 is configured by using an user interface such as a keyboard, a button, a lever, a touch panel that is provided by being stacked on a display constituting the output unit 44, and a microphone for inputting voices and the input unit 43 receives various information items input thereto.

The output unit 44 is configured by using a display for a displaying operation that is configured by using liquid crystal or organic electro luminescence (EL), a speaker for outputting voices, or the like.

The controller 45 controls the collection and delivery agent terminal 4. The controller 45 is a processor configured by using one or a combination of pieces of hardware such as a CPU or an FPGA. The controller 45 performs various calculation processes for operating the collection and delivery agent terminal 4 by reading various programs stored in the storage unit 46.

The storage unit 46 stores various programs for operating the collection and delivery agent terminal 4. The storage unit 46 is configured by using a RAM, a ROM, and the like.

Note that, the collection and delivery agent terminal 4 may further include an imaging unit configured by using an image sensor such as a CCD or a CMOS. In this case, the collection and delivery agent images the state of a vehicle cabin by using the collection and delivery agent terminal 4 and transmits data of a captured image to the management server 2. The management server 2 grasps the availability of the vehicle cabin by means of image recognition based on the received data of the image.

In addition, as an application that can be downloaded by the collection and delivery agent terminal 4, an application that displays parking and stopping information of the vehicles 11 parked or stopped in the region R may be provided.

### Vehicle-Mounted Device 5

The vehicle-mounted device 5 is installed in the vehicle 11. The vehicle-mounted device 5 includes a locking and unlocking device 51, the key unit 52, and a control device 53. The vehicle-mounted device 5 operates the locking and unlocking device 51 after an authentication process performed by the key unit 52 based on authentication information transmitted from the collection and delivery agent terminal 4 or the request source terminal 6, so as to perform a series of processes of locking or unlocking the vehicle cabin of the vehicle 11. In addition, the control device 53 of the vehicle-mounted device 5 detects the position or the state of movement of the vehicle 11 and transmits detected information to the management server 2 via the communication network NW. An expiration date is set for authentication information of the collection and delivery agent terminal 4 and the request source terminal 6. In other words, the collection and delivery agent terminal 4 and the request source terminal 6 need to acquire authentication information from the center server 3 each time a package is collected and delivered.

The locking and unlocking device 51 is a device for locking or unlocking doors of the vehicle cabin of the vehicle 11. The locking and unlocking device 51 includes an LF transmitter 511, an RF receiver 512, a controller 513, a door lock actuator 514, and a storage unit 515. Note that, in FIG. 2, the door lock actuator is shown as “door lock A”.

The LF transmitter 511 transmits a low-frequency band (for example, 100 KHz to 300 KHz) radio wave for searching for (polling) the key unit 52. The LF transmitter 511 is built in the vicinity of a center console or a steering wheel in the vehicle cabin, for example.

The RF receiver 512 receives a high-frequency band (for example, 100 MHz to 1 GHz) radio wave transmitted from the key unit 52. The RF receiver 512 is built into any place in the vehicle cabin.

The controller 513 collates a key ID included in locking and unlocking signals received from the key unit 52 and a key ID stored in the storage unit 515 with each other. When the controller 513 determines that the received key ID is rightful as the result of the collation, the controller 513 transmits, to the door lock actuator 514, a signal for locking or unlocking the doors of the vehicle cabin of the vehicle 11 which is for package reception.

The controller 513 is configured by using one or a combination of pieces of hardware such as a CPU or an FPGA. The controller 513 may be configured by using a plurality of electric control units (ECU), the ECUs being communicatably connected to each other via an in-vehicle network such as a controller area network (CAN). In the following description, a locking signal and an unlocking signal may be collectively referred to as locking and unlocking signals.

The door lock actuator 514 is an actuator that locks or unlocks the doors of the vehicle cabin of the vehicle 11. The door lock actuator 514 is operated based on locking and unlocking signals transmitted from the controller 513. Note that, the door lock actuator 514 may lock or unlock the doors of the vehicle 11 independently of each other. For example, a configuration in which a trunk is locked or unlocked solely in a case where the trunk is used as the vehicle cabin for package reception may also be adopted.

The storage unit 515 stores various information items including a key ID of the doors of the vehicle cabin and various programs for operating the locking and unlocking device 51. The storage unit 515 is configured by using a RAM, a ROM, and the like.

The key unit 52 includes an LF receiver 521, an RF transmitter 522, a short-range communication unit 523, a controller 524, and a storage unit 525. The key unit 52 is disposed at a predetermined position in a glove box or the like in the vehicle cabin of the vehicle 11, for example.

The LF receiver 521 receives a polling signal that is transmitted from the locking and unlocking device 51 via a low-frequency band radio wave. The LF receiver 521 includes an antenna (hereinafter, referred to as LF antenna) for reception of a low-frequency band radio wave.

The RF transmitter 522 transmits locking and unlocking signals to the locking and unlocking device 51 via high-frequency band radio waves.

The short-range communication unit 523 is a communication interface that communicates with the collection and delivery agent terminal 4 or the request source terminal 6 by means of short-range wireless communication.

The controller 524 controls the key unit 52. The controller 524 compares authentication information included in a locking request or an unlocking request received from the collection and delivery agent terminal 4 or the request source terminal 6 with authentication information stored in the storage unit 525 and determines that authentication is successful in a case where the authentication information item included in the locking request or the unlocking request and the authentication information stored in the storage unit 525 are in a predetermined relationship. Examples of the predetermined relationship include any of a relationship in which the authentication information stored in the storage unit 525 coincides with the authentication information received from the collection and delivery agent terminal 4 or the request source terminal 6, a relationship in which the results of a predetermined encoding or decoding process performed by means of the two items of authentication information coincide with each other, and a relationship in which the result of a decoding process performed on one of the two items of authentication information coincides with the result of a decoding process performed on the other of the two items of authentication information.

In a case where the controller 524 succeeds in authenticating the collection and delivery agent terminal 4 or the request source terminal 6, the controller 524 transmits, to the locking and unlocking device 51 via the RF transmitter 522, locking and unlocking signals that are generated in response to a request received from the collection and delivery agent terminal 4 or the request source terminal 6.

The controller 524 is configured by using one or a combination of pieces of hardware such as a CPU or an FPGA.

The storage unit 525 stores the authentication information for the authentication of the collection and delivery agent terminal 4 or the request source terminal 6 and stores a key ID. Note that, the storage unit 525 may store the key ID in an encoded state. In a case where the storage unit 525 stores the key ID in an encoded state, the controller 524 receives information of decryption from the collection and delivery agent terminal 4 or the request source terminal 6 and decodes the key ID based on the information.

The storage unit 525 stores various programs for operating the key unit 52. The storage unit 525 is configured by using a RAM, a ROM, and the like. The authentication information stored in the storage unit 525 may be referred to as device authentication information and authentication information transmitted by the collection and delivery agent terminal 4 or the request source terminal 6 may be referred to as terminal authentication information.

The key unit 52 configured as described above communicates with the locking and unlocking device 51 included in the vehicle-mounted device 5 such that it is possible to lock or unlock the vehicle cabin of the vehicle 11 without using a physical key.

The control device 53 includes a communication unit 531, a position detection unit 532, a speed detection unit 533, an input unit 534, an output unit 535, a controller 536, and a storage unit 537.

The communication unit 531 is an interface that communicates with the management server 2 via the communication network NW. The communication unit 531 transmits position information, speed information, and schedule information of the vehicle 11 to the management server 2.

The position detection unit 532 is configured by using a global positioning system (GPS) sensor that receives a GPS signal transmitted by a GPS satellite, detects information about the position of the vehicle 11 that includes the latitude and the longitude of the vehicle 11 based on a received signal, and outputs the information to the controller 536. Note that, as a method of detecting the position information of the vehicle 11 by means of the position detection unit 532, a method obtained by a combination of light detection and ranging (LiDAR) (laser imaging detection and ranging) and a three-dimensional digital map may be adopted.

The speed detection unit 533 is configured by using a vehicle speed sensor or the like, detects information about the speed of the vehicle 11, and outputs the information to the controller 536.

Note that, the position detection unit 532 and the speed detection unit 533 may detect information about the position and the speed by performing mobile communication conforming to communication standards such as 3G, 4G, 5G, and long term evolution (LTE). In this case, the information about the position and the speed may be detected by means of mobile communication with another vehicle, various sensors provided in the vicinity of a road on which the vehicle 11 is traveling, and a server that acquires information from the vehicles and the various sensors.

The input unit 534 and the output unit 535 respectively have the same functional configurations as the input unit 43 and the output unit 44 described above. The input unit 534 receives schedule information of the vehicle 11 input thereto by the owner of the vehicle 11. The schedule information of the vehicle 11 herein includes a date and time of departure from the region R of the vehicle 11 and a date and time of arrival at the region R of the vehicle 11. Note that, as the schedule information, information relating to whether or not the vehicle cabin of the vehicle 11 in a state of being parked or stopped in the region R can be used may be included.

The controller 536 controls the control device 53. The controller 536 is a processor configured by using one or a combination of pieces of hardware such as a CPU or an FPGA and performs various calculation processes for operating the control device 53 by reading various programs stored in the storage unit 537.

The storage unit 537 stores various kinds of information including the results of detection performed by the position detection unit 532 and the speed detection unit 533, the schedule information of the vehicle 11, and various programs for operating the control device 53. The storage unit 537 is configured by using a RAM, a ROM, and the like.

Note that, the vehicle-mounted device 5 may be further provided with a vehicle-mounted camera or a weight sensor as means for confirming the availability of the vehicle cabin. In this case, the vehicle-mounted device 5 transmits data of an image captured by the vehicle-mounted camera to the management server 2. The management server 2 grasps the availability of the vehicle cabin by means of image recognition based on the received data of the image. The vehicle-mounted camera may be configured to perform an imaging operation while the vehicle cabin is in an unlocked state.

In addition, a configuration, in which a reader that can read information on a recording medium such as a two-dimensional code is provided in the vehicle cabin, a recording medium that can be read by the reader is attached to a packing material for a package, and the reader reads information on the recording medium and transmits a fact that the package is accommodated in the vehicle cabin to the management server 2 in a case where the package is accommodated at a predetermined position in the vehicle cabin, may also be adopted.

### Request Source Terminal 6

The request source terminal 6 has the same functional configuration as the collection and delivery agent terminal 4. Specifically, the request source terminal 6 includes a communication unit 61, a short-range communication unit 62, an input unit 63, an output unit 64, a controller 65, and a storage unit 66. The functional configurations of the communication unit 61, the short-range communication unit 62, the input unit 63, the output unit 64, the controller 65, and the storage unit 66 are the same as the functional configurations of the communication unit 41, the short-range communication unit 42, the input unit 43, the output unit 44, the controller 45, and the storage unit 46. In a case where a request source is a private user, the request source terminal 6 is a terminal associated with the user and in a case where a request source is a package collection and delivery place, the request source terminal 6 is a terminal associated with the collection and delivery place. The following description will be made on the assumption that the request source terminal 6 is a terminal associated with a private user.

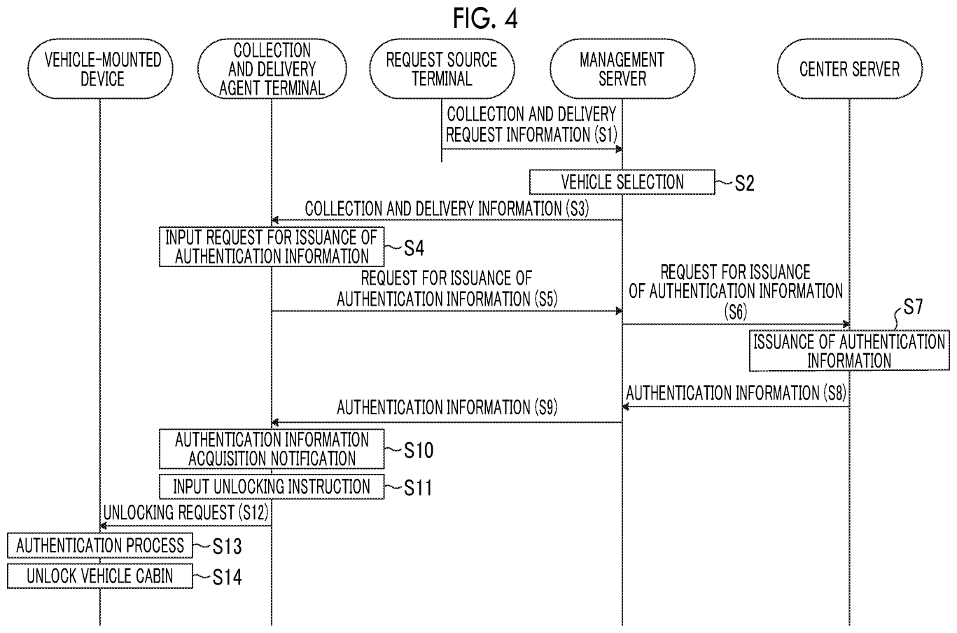

FIG. 4 is a sequence diagram illustrating the outline of processing performed in the collection and delivery system 1. FIG. 4 illustrates the outline of processing performed in a case where the request source terminal 6 makes a request for delivery of a package to the region R and processing performed until the vehicle cabin of the vehicle 11 as a delivery destination is unlocked.

The request source terminal 6 transmits collection and delivery request information of a package to the management server 2 (step S1). The collection and delivery request information includes information such as the kind of the package, information about a requester of collection and delivery, the time of collection and delivery, and the position of the region R.

In the management server 2 that has received the collection and delivery request information, the selection unit 24 selects a vehicle as a collection and delivery destination based on the collection and delivery request information and the parking and stopping information of the vehicles 11 in the region R (step S2). Thereafter, under the control of the controller 22, the communication unit 21 transmits, to the collection and delivery agent terminal 4, collection and delivery information that includes at least a portion of the collection and delivery request information and information of the vehicle 11 selected by the selection unit 24 (step S3).

Thereafter, when a collection and delivery agent carrying the collection and delivery agent terminal 4 arrives at the region R, the collection and delivery agent performs a process of unlocking the vehicle cabin of the vehicle 11 as the delivery destination by using the collection and delivery agent terminal 4. First, the input unit 43 of the collection and delivery agent terminal 4 receives a request for issuance of authentication information which is input thereto through an operation performed by the collection and delivery agent (step S4). Next, under the control of the controller 45, the communication unit 41 transmits the request for issuance of the authentication information to the management server 2 (step S5). The request for issuance of the authentication information that the communication unit 41 transmits includes information of the vehicle 11 as the delivery destination and terminal information of the collection and delivery agent terminal 4.

In the management server 2 that has received the request for issuance of the authentication information from the collection and delivery agent terminal 4, the communication unit 21 transmits the request for issuance of the authentication information to the center server 3 under the control of the controller 22 (step S6).

In the center server 3 that has received the request for issuance of the authentication information, the authentication information issuing unit 34 issues the authentication information based on the request for issuance of the authentication information (step S7). At this time, the authentication information issuing unit 34 issues the authentication information in a case where a determination is made that the vehicle 11 to be authenticated is a vehicle selected for collection and delivery and the collection and delivery agent terminal 4 is a rightful terminal.

Thereafter, under the control of the controller 32, the communication unit 31 transmits the authentication information to the management server 2 (step S8).

The communication unit 21 in the management server 2 that has received the authentication information from the center server 3 transmits the received authentication information to the collection and delivery agent terminal 4 under the control of the controller 22 (step S9).

In the collection and delivery agent terminal 4 that has received the authentication information from the management server 2, the output unit 44 outputs authentication information acquisition notification (step S10). Thereafter, when the input unit 43 receives an unlocking instruction that is input thereto through an operation performed by the collection and delivery agent (step S11), the short-range communication unit 42 transmits, to the vehicle-mounted device 5 of the vehicle 11 to be unlocked, an unlocking request including the authentication information (step S12). To perform the process in step S12, the collection and delivery agent terminal 4 needs to be positioned in a range in which the collection and delivery agent terminal 4 can communicate with the vehicle-mounted device 5 of the vehicle 11 to be unlocked.

In the vehicle-mounted device 5, the key unit 52 that has received the unlocking request performs an authentication process (step S13). Specifically, after the short-range communication unit 523 receives the unlocking request, the controller 524 performs the authentication process by comparing the authentication information (terminal authentication information) included in the unlocking request with authentication information (device authentication information) stored in the storage unit 525. In a case where the authentication is successful, the controller 524 causes the RF transmitter 522 to transmit an unlocking signal including a key ID.

When the RF receiver 512 of the locking and unlocking device 51 receives the unlocking signal, the locking and unlocking device 51 unlocks the vehicle cabin of the vehicle 11 which is for package reception (step S14). Specifically, first, the controller 513 collates key IDs each other and when the collation between the key IDs is successful, the controller 513 controls the door lock actuator 514 such that the vehicle cabin of the vehicle 11, which is for package reception, is unlocked. Note that, at this time, the locking and unlocking device 51 may send an answerback or the like with respect to the key unit 52.

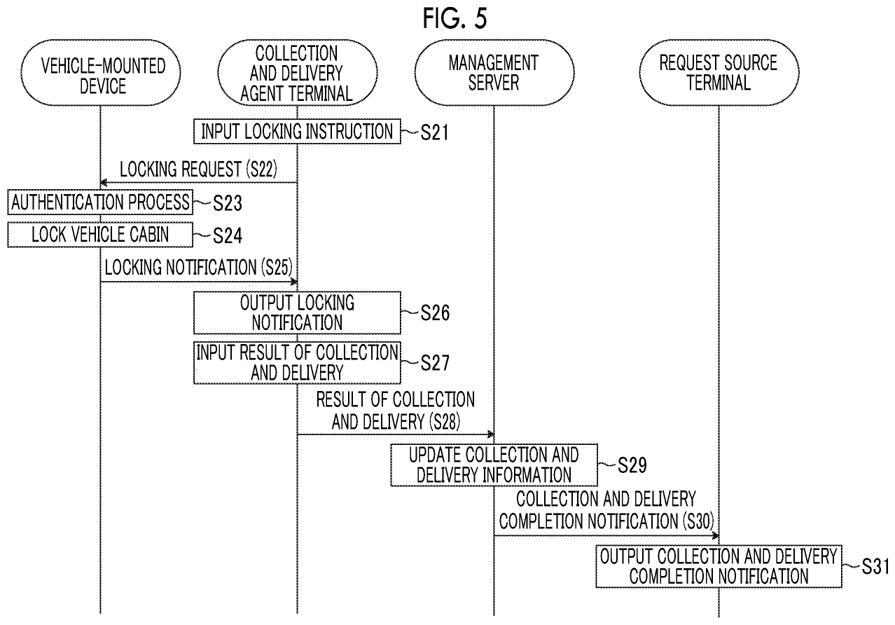

FIG. 5 is a sequence diagram illustrating the outline of processing performed in the collection and delivery system 1 and the outline of a process of locking the vehicle cabin of the vehicle 11 after the package is delivered by the collection and delivery agent.

First, when the input unit 43 of the collection and delivery agent terminal 4 receives a locking instruction that is input thereto through an operation performed by the collection and delivery agent (step S21), the short-range communication unit 42 transmits the locking request to the vehicle-mounted device 5 of the vehicle 11 to be locked under the control of the controller 45 (step S22). To perform the process in step S21, the collection and delivery agent terminal 4 needs to be positioned in a range in which the collection and delivery agent terminal 4 can communicate with the vehicle-mounted device 5 of the vehicle 11 to be locked.

In the vehicle-mounted device 5, the key unit 52 that has received the locking request performs an authentication process (step S23). Specifically, after the short-range communication unit 523 receives the locking request, the controller 524 performs the authentication process by comparing the authentication information (terminal authentication information) included in the locking request with the authentication information (device authentication information) stored in the storage unit 525. In a case where the authentication is successful, the controller 524 causes the RF transmitter 522 to transmit a locking signal including a key ID.

When the RF receiver 512 of the locking and unlocking device 51 receives the locking signal, the locking and unlocking device 51 locks the vehicle cabin of the vehicle 11 which is for package reception (step S24). Specifically, first, the controller 513 collates key IDs each other and when the collation between the key IDs is successful, the controller 513 controls the door lock actuator 514 such that the vehicle cabin of the vehicle 11, which is for package reception, is locked.

Next, the vehicle-mounted device 5 transmits a locking notification signal to the collection and delivery agent terminal 4 (step S25). Specifically, processing at this time is as follows. First, the LF transmitter 511 of the locking and unlocking device 51 transmits the locking notification signal to the key unit 52. In the key unit 52 that has received the locking notification signal, the short-range communication unit 523 transmits the locking notification signal to the collection and delivery agent terminal 4 under the control of the controller 524. At the time of the transmission as well, the collection and delivery agent terminal 4 needs to be positioned in a range in which the collection and delivery agent terminal 4 can communicate with the vehicle-mounted device 5.

In the collection and delivery agent terminal 4 that has received the locking notification signal, the output unit 44 outputs locking notification (step S26). Next, when the input unit 43 receives the result of collection and delivery that is input thereto through an operation performed by the collection and delivery agent (step S27), the communication unit 41 transmits the result of collection and delivery to the management server 2 under the control of the controller 45 (step S28).

In the management server 2 that has received the result of collection and delivery, the controller 22 updates the collection and delivery information and the parking and stopping information in the storage unit 23 (step S29).

Thereafter, under the control of the controller 22, the communication unit 21 of the management server 2 transmits collection and delivery completion notification to the request source terminal 6 (step S30).

The output unit 64 of the request source terminal 6 outputs information about the received collection and delivery completion notification (step S31). Thereafter, the user unlocks the vehicle cabin of the vehicle 11, in which the package is accommodated, by using the request source terminal 6 and locks the vehicle cabin after receiving the package. The outline of an unlocking and locking process performed by means of the request source terminal 6 is the same as that of the unlocking and locking process performed by means of the collection and delivery agent terminal 4 (steps S4 to S14 and S21 to S29).

Although a case where the collection and delivery agent delivers a package has been described so far, the same applies to a case where the collection and delivery agent collects a package. In a case where the collection and delivery agent collects a package, first, the request source terminal 6 receives information about the vehicle 11 selected for collection and delivery from the management server 2, the vehicle cabin of the vehicle 11 is unlocked, and a package that is a collection and delivery target is accommodated therein. Thereafter, the vehicle cabin is locked. Then, when the collection and delivery agent collects the package, the collection and delivery agent collects the package by unlocking the vehicle cabin of the vehicle 11 by means of the collection and delivery agent terminal 4. Thereafter, the vehicle cabin is locked. An unlocking and locking process performed by means of the collection and delivery agent terminal 4 and the request source terminal 6 is the same as the above-described unlocking and locking process (steps S4 to S14 and S21 to S29).

According to Embodiment 1 as described above, since a vehicle for collection and delivery of a package that is a collection and delivery target is selected based on parking and stopping information that includes information about the positions of a plurality of vehicles parked or stopped in a predetermined region, of which vehicle cabins are usable for package reception, and information about the parking and stopping of the vehicles, it is possible to select a vehicle conforming to a parking and stopping situation and thus it is possible to effectively utilize a vehicle registered for package reception in a predetermined region.

In addition, according to Embodiment 1, a person who owns no vehicle also can use a vehicle cabin and it is possible to effectively use a vehicle in a case where a person has few chances to board the vehicle even though the person is the owner of the vehicle.

In addition, according to Embodiment 1, since a vehicle for collection and delivery is selected with the parking and stopping information being referred to, it is possible to optimize package distribution.

### Embodiment 2

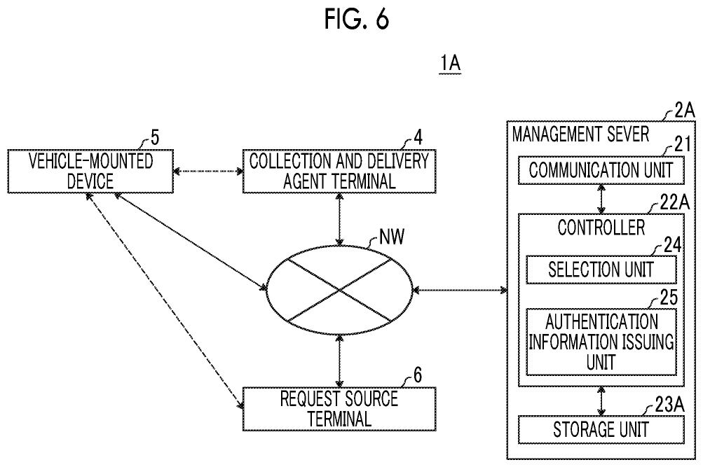

FIG. 6 is a block diagram illustrating the functional configuration of a collection and delivery system provided with a vehicle selection apparatus according to Embodiment 2. A collection and delivery system 1A shown in FIG. 6 is provided with a management server 2A, the collection and delivery agent terminal 4, the vehicle-mounted device 5, and the request source terminal 6. In Embodiment 2, the management server 2A has functions as a vehicle selection apparatus, a vehicle management apparatus, and an authentication management apparatus. Therefore, the collection and delivery system 1A does not include a center server.

The functional configuration of the management server 2A will be described. The management server 2A includes the communication unit 21, a controller 22A, and a storage unit 23A. The management server 2A is the vehicle selection apparatus according to Embodiment 2.

The controller 22A includes the selection unit 24 and an authentication information issuing unit 25. As with the above-described authentication information issuing unit 34, the authentication information issuing unit 25 issues authentication information for the locking or unlocking of the vehicles 11. The controller 22A is a processor configured by using one or a combination of pieces of hardware such as a CPU or an FPGA and performs various calculation processes for operating the management server 2A by reading various programs stored in the storage unit 23A.

The storage unit 23A stores information needed for the authentication information issuing unit 25 to issue authentication information, in addition to the parking and stopping information or the like stored in the storage unit 23. The storage unit 23A is configured by using a RAM, a ROM, and the like.

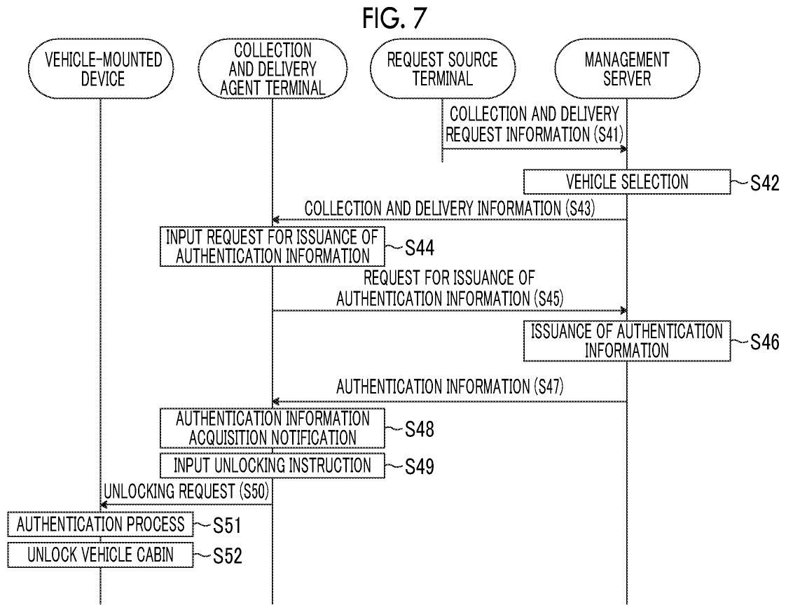

FIG. 7 is a sequence diagram illustrating the outline of processing performed in the collection and delivery system 1A. FIG. 7 illustrates the outline of processing performed between when the request source terminal 6 makes a request for delivery of a package to the region R and when the vehicle cabin of the vehicle 11 as a delivery destination is unlocked.

Processes in steps S41 to S45 correspond to the processes in steps S1 to S5 described with reference to FIG. 4, respectively.

Thereafter, in the management server 2A, the authentication information issuing unit 25 issues authentication information based on a request for issuance of the authentication information (step S46). The details of processing performed by the authentication information issuing unit 25 is the same as the details of the above-described processing performed by the authentication information issuing unit 34.

Thereafter, under the control of the controller 22A, the communication unit 21 transmits the authentication information to the collection and delivery agent terminal 4 (step S47).

Processes in steps S48 to S52 correspond to the processes in steps S10 to S14 described with reference to FIG. 4, respectively.

The outline of a process of locking the vehicle cabin of the vehicle 11 after the collection and delivery agent delivers the package is the same as that in Embodiment 1 (refer to FIG. 5).

According to Embodiment 2 described above, as with Embodiment 1, it is possible to effectively utilize a vehicle registered for package reception in a predetermined region.

In addition, according to Embodiment 2, since collection and delivery management and locking and unlocking management are comprehensively performed, it is possible to realize efficient management.

### Embodiment 3

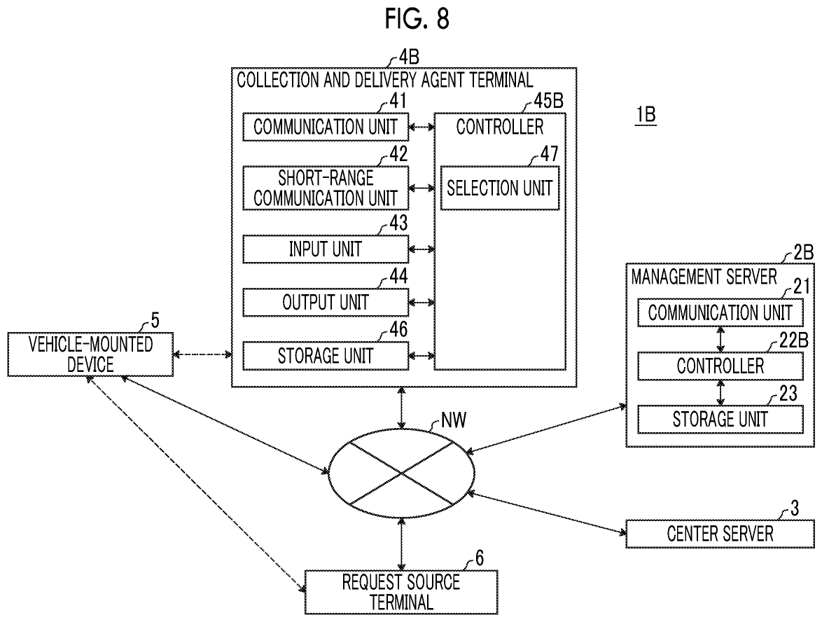

FIG. 8 is a block diagram illustrating the functional configuration of a collection and delivery system provided with a vehicle selection apparatus according to Embodiment 3. A collection and delivery system 1B shown in FIG. 8 is provided with a management server 2B, the center server 3, a collection and delivery agent terminal 4B, the vehicle-mounted device 5, and the request source terminal 6. Hereinafter, the functional configurations of constituent elements (management server 2B and collection and delivery agent terminal 4B), of which the functional configurations are different from those in Embodiment 1, will be described.

The management server 2B includes the communication unit 21, a controller 22B, and the storage unit 23. The controller 22B does not include a selection unit.

The collection and delivery agent terminal 4B includes the communication unit 41, the short-range communication unit 42, the input unit 43, the output unit 44, a controller 45B, and the storage unit 46. The controller 45B includes a selection unit 47 that selects a vehicle for collection and delivery of a package based on parking and stopping information of the vehicles 11 and collection and delivery information, which are acquired from the management server 2. The controller 45B is a processor configured by using one or a combination of pieces of hardware such as a CPU or an FPGA and performs various calculation processes for operating the collection and delivery agent terminal 4B by reading various programs stored in the storage unit 46. The collection and delivery agent terminal 4B having such a functional configuration is a vehicle selection apparatus according to Embodiment 3.

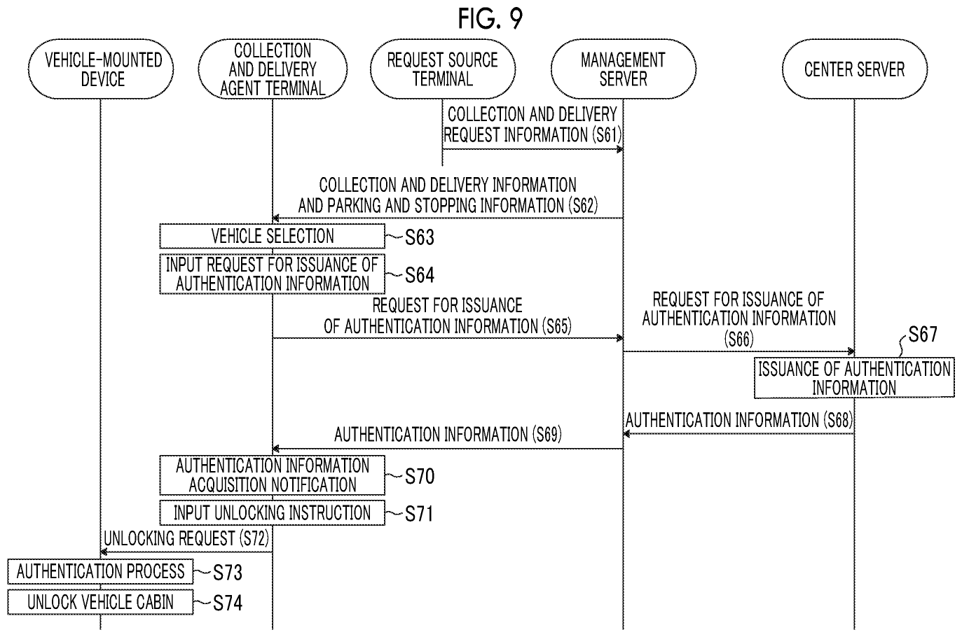

FIG. 9 is a sequence diagram illustrating the outline of processing performed in the collection and delivery system 1B. FIG. 9 illustrates the outline of processing performed between when the request source terminal 6 makes a request for delivery of a package to the region R and when the vehicle cabin of the vehicle 11 as a delivery destination is unlocked.

The request source terminal 6 transmits collection and delivery request information of a package to the management server 2B (step S61).

In the management server 2B that has received the collection and delivery request information, the collection and delivery agent terminal 4 for collection and delivery agent of the requested package is assigned with the request information being referred to and parking and stopping information of the vehicles 11 parked or stopped in the region R, which is the delivery destination of the package, is read from the storage unit 23 and is transmitted to the collection and delivery agent terminal 4 along with the request information (step S62).

In the collection and delivery agent terminal 4B that has received the request information and the parking and stopping information, the selection unit 47 selects a vehicle as a collection and delivery destination based on the collection and delivery information and the parking and stopping information of the vehicles 11 in the region R (step S63).

The subsequent processes in steps S64 to S74 correspond to the processes in steps S4 to S14 described in Embodiment 1 with reference to FIG. 4, respectively.

The outline of a process of locking the vehicle cabin of the vehicle 11 after the collection and delivery agent delivers the package is the same as that in Embodiment 1 (refer to FIG. 5).

According to Embodiment 3 described above, as with Embodiment 1, it is possible to effectively utilize a vehicle registered for package reception in a predetermined region.

In addition, according to Embodiment 3, since a vehicle is selected by a collection and delivery side, it is possible to improve the convenience of a collection and delivery agent.

### Embodiment 4

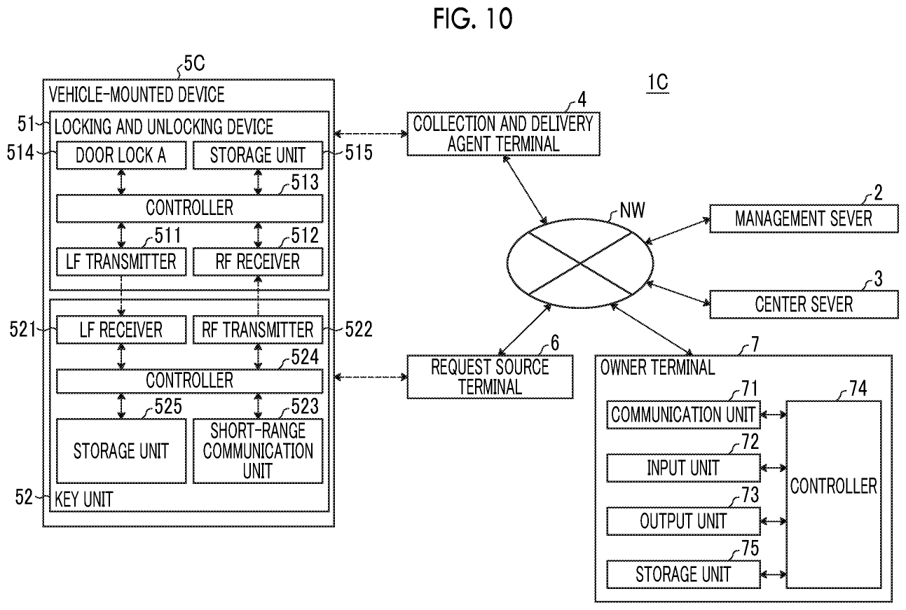

FIG. 10 is a block diagram illustrating the functional configuration of a collection and delivery system provided with a vehicle selection apparatus according to Embodiment 4. A collection and delivery system 1C shown in FIG. 10 is provided with the management server 2, the center server 3, the collection and delivery agent terminal 4, a vehicle-mounted device 5C, the request source terminal 6, and an owner terminal 7. Hereinafter, the functional configurations of constituent elements, of which the functional configurations are different from those in Embodiment 1, will be described.

The vehicle-mounted device 5C includes the locking and unlocking device 51 and the key unit 52. The vehicle-mounted device 5C does not include the control device 53 that the vehicle-mounted device 5 in Embodiment 1 includes.

The owner terminal 7 is a terminal associated with the owner of the vehicle 11 and has the same functional configuration of the collection and delivery agent terminal 4. Specifically, the owner terminal 7 includes a communication unit 71, an input unit 72, an output unit 73, a controller 74, and a storage unit 75. The functional configurations of the communication unit 71, the input unit 72, the output unit 73, the controller 74, and the storage unit 75 are the same as the functional configurations of the communication unit 41, the input unit 43, the output unit 44, the controller 45, and the storage unit 46.

In Embodiment 4, the owner of the vehicle 11 inputs schedule information of the vehicle 11 by operating the input unit 72 of the owner terminal 7 and the schedule information is transmitted to the management server 2.

The selection unit 24 of the management server 2 selects, based on the schedule information received from the owner terminal 7, the vehicle 11 as a delivery destination corresponding to the request information received from the request source terminal 6.

According to Embodiment 4 described above, as with Embodiment 1, it is possible to effectively utilize a vehicle registered for package reception in a predetermined region. Particularly, according to Embodiment 4, it is possible to effectively utilize the vehicle registered for package reception even in a case where no control device is installed in the vehicle.

### Other Embodiments

Hereinabove, the embodiments have been described. However, the disclosure is not to be limited by Embodiments 1 to 4 described above. For example, a selection unit may select a vehicle for collection and delivery of a package while referring to information about a condition for collection and delivery that is registered in advance by the owners of vehicles. Examples of the condition for collection and delivery include a condition relating to the kind of the package, a weight, and a period of time for collection and delivery.

In addition, a selection unit may select a vehicle such that vehicles are selected in order of rating while referring to parking and stopping information and at least any of the result of post evaluation of a vehicle cabin as a delivery destination that is made by a request source or a collection and delivery agent and the result of evaluation of a collection and delivery agent that is made by the owner of a vehicle of which the vehicle cabin is provided. In addition, a client evaluation criterion that can be used by a request source or a vehicle owner may be able to be set and a selection unit may select a vehicle for package reception while referring to the evaluation criterion also.

In addition, in a case where a plurality of packages can be accommodated into one vehicle cabin, a combination of the types of packages that can be accommodated at the same time may be set in advance and stored in a storage unit of a vehicle selection apparatus and a selection unit may select a vehicle based on the result of the setting. Accordingly, it is possible to prevent a situation in which an ingredient, which causes a smell, and clothes, which are preferably not saturated with the smell of the ingredient, are stored in the same vehicle cabin at the same time.

In addition, an edge computing technology, in which terminals that can perform a part of processing performed by a management server and a center server are disposed in a scattering manner at places physically close to a collection and delivery agent terminal and with which it is possible to efficiently communicate a large amount of data and reduce a time taken for a calculation process, may also be applied instead of a collection and delivery system provided with one management server and one center server.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A vehicle selection apparatus comprising:
a memory; and
a processor including hardware,
wherein the processor selects a vehicle for collection and delivery of a package that is a collection and delivery target, based on parking and stopping information that includes information about positions of a plurality of vehicles parked or stopped in a predetermined region, of which vehicle cabins are usable for package reception, and information about parking and stopping of the vehicles.

2. The vehicle selection apparatus according to claim 1, wherein the processor selects the vehicle for collection and delivery of the package while referring to schedule information that is registered by each of owners of the vehicles.

3. The vehicle selection apparatus according to claim 1, wherein the processor selects the vehicle for collection and delivery of the package while referring to information about a condition for collection and delivery that is registered in advance by owners of the vehicles.

4. The vehicle selection apparatus according to claim 1, wherein the processor selects the vehicle for collection and delivery of the package in accordance with a kind of the package.

5. The vehicle selection apparatus according to claim 1, wherein the processor selects the vehicle for collection and delivery of the package while referring to evaluation information obtained through evaluation performed by at least any of a past collection and delivery service user, owners of the vehicles, and a collection and delivery agent of the package.

6. The vehicle selection apparatus according to claim 1, wherein the processor transmits collection and delivery information of the package that includes information about the selected vehicle to a collection and delivery agent terminal that is associated with a collection and delivery agent of the package and that transmits a signal requesting the selected vehicle to lock or unlock a vehicle cabin.

7. The vehicle selection apparatus according to claim 6, wherein the processor receives a request for issuance of authentication information, which is needed to lock or unlock the vehicle cabin of the selected vehicle, from the collection and delivery agent terminal, transmits the request for issuance to an authentication management apparatus that manages the authentication information, and transmits the authentication information received from the authentication management apparatus to the collection and delivery agent terminal.

8. The vehicle selection apparatus according to claim 6, wherein the processor receives a request for issuance of authentication information, which is needed to lock or unlock the vehicle cabin of the selected vehicle, from the collection and delivery agent terminal, issues the authentication information in response to the request for issuance, and transmits the issued authentication information to the collection and delivery agent terminal.

9. The vehicle selection apparatus according to claim 1, wherein the processor acquires collection and delivery information of the package and parking and stopping information of the vehicles from a vehicle management apparatus that manages the parking and stopping information of the vehicles, transmits a request for issuance of authentication information, which is needed to lock or unlock a vehicle cabin of the selected vehicle, to the vehicle management apparatus after selection of the vehicle for collection and delivery of the package, and transmits a vehicle cabin unlocking request to a vehicle-mounted device of the selected vehicle by using the authentication information received from the vehicle management apparatus.

10. A vehicle selection method performed by a vehicle selection apparatus that includes a memory and a processor including hardware, the method comprising:
reading, from the memory, parking and stopping information that includes information about positions of a plurality of vehicles parked or stopped in a predetermined region, of which vehicle cabins are usable for package reception, and information about parking and stopping of the vehicles to select a vehicle for collection and delivery of a package that is a collection and delivery target.

11. A vehicle selection program executed by a vehicle selection apparatus that includes a memory and a processor including hardware, the program causing the vehicle selection apparatus to select a vehicle for collection and delivery of a package that is a collection and delivery target based on parking and stopping information that includes information about positions of a plurality of vehicles parked or stopped in a predetermined region, of which vehicle cabins are usable for package reception, and information about parking and stopping of the vehicles.
